(19) United States
(12) Patent Application Publication
(10) Pub. No.: US 2024/0391441 A1
(43) Pub. Date: Nov. 28, 2024

(54) BRAKE SYSTEM FOR AN ELECTRIC VEHICLE, ELECTRIC VEHICLE AND METHOD FOR OPERATING A BRAKE SYSTEM IN AN ELECTRIC VEHICLE

(71) Applicant: Robert Bosch GmbH, Stuttgart (DE)

(72) Inventors: Herbert Vollert, Vaihingen/Enz (DE); Willi Nagel, Remseck/Hochdorf (DE)

(21) Appl. No.: 18/694,753

(22) PCT Filed: Dec. 5, 2022
(86) PCT No.: PCT/EP2022/084362

§ 371 Date: Mar. 22, 2024

(30) Foreign Application Priority Data
Dec. 23, 2021 (DE) 10 2021 215 001.2

(51) Int. Cl. B60T 13/74; B60L 1/00; B60T 13/14

(52) U.S. Cl. CPC B60T 13/745; B60L 1/003; B60T 13/142; B60T 13/148; B60T 2270/306; B60T 2270/402; B60T 2270/413

(57) ABSTRACT

A brake system for an electric vehicle, having two independent pressure build-up devices for building up hydraulic pressure in the brake circuits of the brake system. One of the pressure build-up devices is supplied with electrical energy via the high-voltage network of the electric vehicle. The other pressure build-up device is supplied with electrical energy via the low-voltage network of the electric vehicle.

### FIELD

The present invention relates to a brake system, in particular to a brake system for an electric vehicle, and to an electric vehicle having such a brake system. The present invention also relates to a method for operating a brake system in an electric vehicle.

### BACKGROUND INFORMATION

Vehicles, in particular motor vehicles, generally have a brake system capable of safely braking a moving vehicle to a stop. For this purpose, hydraulic brake systems are often used. When actuating the brake, a user may be assisted by a brake booster, for example a vacuum brake booster or an electromechanical brake booster. In addition, assistance systems, such as an anti-lock brake system (ABS) or an electronic stability program (ESP), are available, which can actively influence the braking behavior of a vehicle.

German Patent Application No. DE 10 2012 205 861 A1, for example, describes a hydraulic brake system with a master brake cylinder, two brake pressure generators, at least one wheel brake cylinder, and interruption means for redundant brake pressure generation and brake pressure control with electrical support.

### SUMMARY

Provided according to an example embodiment of the present invention is:

A brake system for an electric vehicle, in particular an electric vehicle having a high-voltage network and a low-voltage network. The brake system comprises a first pressure build-up device and a second pressure build-up device. The first pressure build-up device is designed to build up hydraulic pressure in at least one brake circuit. The second pressure build-up device is likewise designed to build up hydraulic pressure in the at least one brake circuit. The first pressure build-up device is in particular designed to be supplied with electrical energy from the high-voltage network of the electric vehicle. The second pressure build-up device is designed to be supplied with electrical energy from the low-voltage network of the electric vehicle.

Provided according to an example embodiment of the present invention is furthermore:

An electric vehicle having a high-voltage network, a low-voltage network, and a brake system according to the present invention for the electric vehicle.

Provided according to an example embodiment of the present invention is also:

A method for operating a brake system according to the present invention in an electric vehicle. The method comprises a step of operating the first pressure build-up device using electrical energy from the high-voltage network of the electric vehicle and a step of operating the second pressure build-up device using electrical energy from the low-voltage network of the electric vehicle.

The present invention is based on the knowledge that, for safety reasons, particularly high requirements are placed on the failure safety of a brake system in a motor vehicle. For this purpose, it is inter alia provided for reasons of redundancy to supply electrical energy to the components of such a brake system by means of at least two independent energy supply systems. This can ensure that, when one energy supply system fails, the brake system can continue to be operated at least to a limited extent by means of the electrical energy from the respectively other energy supply system.

In conventional systems, two independent energy supply systems in the low-voltage range are usually provided for this purpose. Such energy supply networks in the low-voltage range generally have an electrical voltage of less than 50 volts, for example 12 volts or 24 volts. However, the use of a plurality of independent low-voltage networks requires significant effort and associated costs.

It is therefore a feature of the present invention to take this knowledge into account and to provide a brake system in which the redundancy for the electrical energy supply can be realized with only one low-voltage network. For this purpose, it is provided according to the present invention to supply electrical energy in an electric vehicle to a part of the components of the brake system via the high-voltage network of an electric vehicle, in particular directly from the traction battery of the electric vehicle. In addition, a further part of the components of the brake system can be supplied with electrical energy via a low-voltage network of the electric vehicle. Since an electric vehicle usually has both a high-voltage network and a low-voltage network, the brake system can in this way be supplied with electrical energy by the high-voltage network and the low-voltage network by means of two independent energy supply networks. An additional further low-voltage network is thus not required for a redundant energy supply of the brake system in an electric vehicle.

The present invention makes use of the fact that electric drives with an electric motor can be operated over a very broad voltage range and in particular also at higher voltages. It is thus possible to feed electromechanical components, such as those that can be used for controlling a master brake cylinder, directly from a high-voltage network of an electric vehicle. In addition, other components, such as switched or controlled valves in the hydraulic brake circuits, such as those used for vehicle dynamics control, such as an electronic stability program (ESP) or the like, can be operated at the required low voltages from a low-voltage network. The individual components of a brake system according to the present invention can thus be respectively operated with electrical energy at a voltage level suitable for the corresponding components without high effort being required to adjust or convert the provided supply voltages. The brake system can thus be operated by means of two independent energy supply systems without significant additional effort.

Such a brake system with two independent energy supply networks thus provides a sufficient safety reserve even if one of the energy supply networks fails. Such a brake system can thus be operated fully electrically. This means in particular that, even if a mechanical coupling between the master brake cylinder and a brake pedal is omitted, there is a sufficient safety reserve to be able to still provide a suitable hydraulic pressure for braking the vehicle in the event of a fault.

According to an example embodiment of the present invention, the first pressure build-up device comprises a master brake cylinder and an electromechanical drive. The master brake cylinder is designed to build up hydraulic pressure in the at least one brake circuit. The electromechanical drive is designed to actuate the master brake cylinder. In particular, the first pressure build-up device can be designed such that the master brake cylinder is actuatable exclusively by the electromechanical drive. In other words, a mechanical coupling of the master brake cylinder to an external component, such as a brake pedal or the like, is not additionally provided. Here, the electromechanical drive can be designed to be supplied with electrical energy from the high-voltage network of the electric vehicle.

According to an example embodiment of the present invention, the second pressure build-up device comprises a vehicle dynamics control. The vehicle dynamics control can be designed to build up hydraulic pressure in the brake circuits of the brake system. In particular, the vehicle dynamics control can be designed to be supplied with electrical energy from the low-voltage network of the electric vehicle. The vehicle dynamics control may, for example, be an electronic stability program (ESP). Such vehicle dynamics controls generally also comprise a component capable of building up hydraulic pressure in the brake circuits of the brake system. In addition, such vehicle dynamics controls, such as ESPs, also comprise a plurality of valves for controlling the hydraulic pressure in the brake circuits. However, these valves generally require a relatively low operating voltage. In particular, the operating voltage of the valves may be in the range of the voltage level of a low-voltage network. For example, the valves require a control voltage of only a few volts. It is therefore advantageous to supply electrical energy to such a vehicle dynamics control by means of an electrical voltage from a low-voltage network.

On the other hand, electric motors, such as those used for electromechanical drives for actuating a master brake cylinder, can also be operated at higher voltages. It is thus possible to also supply electrical energy to such components directly from the high-voltage network.

According to an example embodiment of the present invention, the high-voltage network comprises a traction battery having a disconnector. Such a disconnector is generally provided directly at the outputs of the traction battery. In this way, during maintenance or an emergency situation, the electrical voltage at the output of the traction battery can be quickly and reliably switched off. For example, such a disconnector may be a so-called manual service disconnect (MSD). Further electrical consumers of the high-voltage network can optionally be connected to the output of such a disconnector via additional protection elements, such as overcurrent protection elements (for example fuses, relays, or the like). In this case, the first pressure build-up device of the brake system is preferably directly connected to the output of the disconnector of the traction battery. This can ensure that even if additional protection elements or switching elements in the high-voltage network are tripped, the brake system, and in particular the first pressure build-up device, continues to be supplied with electrical energy. Thus, even in the event of a fault in the high-voltage network, an energy supply of the first pressure build-up device continues to be possible.

According to an example embodiment of the present invention, the low-voltage network comprises an electrical energy store and a DC voltage converter. The DC voltage converter is designed to convert electrical energy from the high-voltage network to the low-voltage network. Furthermore, the DC voltage converter is designed to charge the electrical energy store of the low-voltage network by means of electrical energy from the high-voltage network. The additional energy store in the low-voltage network, for example a battery or the like, can in this case ensure that sufficient electrical energy to supply electrical energy to the second pressure build-up device is still available in the low-voltage network even if the DC voltage converter between the high-voltage network and the low-voltage network fails.

According to an example embodiment of the present invention, the electromechanical drive of the first pressure build-up device is designed to be operated at an electrical voltage of at least 50 volts. Optionally, the electromechanical drive may also be designed to be operated at an electrical voltage of at least 100 volts, 200 volts, or even more. The electromechanical drive of the first pressure build-up device can thus be controlled directly with electrical energy from the high-voltage network.

According to an example embodiment of the present invention, the first pressure build-up device and the second pressure build-up device are respectively designed to build up the hydraulic pressure exclusively by means of electrically driven actuators. A mechanical coupling of the pressure build-up devices, in particular of the master brake cylinder in the first pressure build-up device, to external components, such as a brake pedal or the like, can thus be omitted. By supplying the brake system by means of two independent electrical energy supply systems, sufficient operational safety can thereby be ensured.

According to an example embodiment of the present invention, the first pressure build-up device and the second pressure build-up device are respectively designed to build up hydraulic pressure in a plurality of independent brake circuits. By using a plurality of independent brake circuits in the brake system, additional redundancy can be created so that, even in the event of a fault, for example a leak or the like in one of the brake circuits, a braking effect is still ensured by the remaining intact brake circuits.

The above configurations and developments can be combined with one another in any desired manner if useful. Further configurations, developments and implementations of the present invention also include not explicitly mentioned combinations of features of the present invention described above or below with respect to the exemplary embodiments. The person skilled in the art will in particular also add individual aspects as improvements or additions to the respective basic forms of the present invention.

### BRIEF DESCRIPTION OF THE DRAWINGS

Further features and advantages of the present invention are explained below with reference to the figures.

FIG. 1 shows a schematic illustration of a block diagram of a hydraulic brake system according to an example embodiment of the present invention.

FIG. 2 shows a schematic illustration of a block diagram of a hydraulic brake system according to a further embodiment of the present invention.

FIG. 3 shows a flowchart as the basis of a method for operating a brake system according to an example embodiment of the present invention.

In the figures, identical reference signs denote identical or functionally identical components unless stated otherwise.

### DETAILED DESCRIPTION OF EXAMPLE EMBODIMENTS

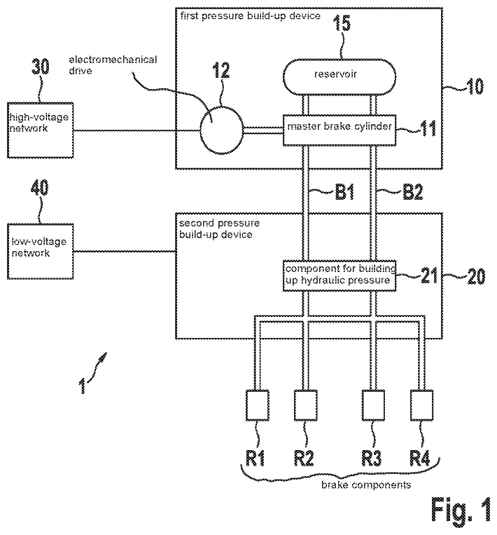

FIG. 1 shows a schematic illustration of a block diagram of a brake system 1 for a vehicle, in particular a motor vehicle that is fully or at least partially electrically driven. The brake system 1 comprises a first pressure build-up device 10 and a second pressure build-up device 20. The first pressure build-up device 10 may, for example, comprise a master brake cylinder 11. When actuated, this master brake cylinder 11 can build up hydraulic pressure in one or more brake circuits B1, B2. In particular, a master brake cylinder 11 may be provided which, when actuated, can build up hydraulic pressure in a plurality of independent brake circuits B1 and B2. For this purpose, the master brake cylinder 11 may, for example, draw hydraulic fluid from a reservoir 15.

The master brake cylinder 11 can be actuated via an electromechanical drive 12. This electromechanical drive 12 may, for example, be an electrically operated actuator, which actuates the master brake cylinder 11 according to a target value specification S. In this way, a hydraulic pressure corresponding to the target value S can be built up in the brake circuits B1 and B2. The electromechanical drive 12 may, for example, be a drive of an electromechanical brake booster. In addition, it is however also possible for the electromechanical drive 12 to receive an electrical target value S and for the master brake cylinder 11 to be actuated exclusively by the electromechanical drive 12. In other words, a mechanical coupling of the master brake cylinder 11 to an external component, such as a brake pedal or the like, is not additionally present.

The brake system 1 also comprises a second pressure build-up device 20. This second pressure build-up device 20 likewise comprises at least one component designed to build up hydraulic pressure in the brake circuits B1 and B2. For example, this component may be an electrically operated hydraulic pump or the like.

The second pressure build-up device 20 may, for example, be a vehicle dynamics control, such as an electronic stability program (ESP) or the like. Such a vehicle dynamics control comprises not only a component 21 for building up hydraulic pressure but also further components, such as electronically controlled valves (not shown).

The arrangement described above of the brake system 1 having the first pressure build-up device 10 and the second pressure build-up device 20 thus makes it possible to provide hydraulic pressure to the brake components R1 to R4, for example wheel brake cylinders or the like. In particular, using two independent pressure build-up devices 10 and 20 makes it possible to realize a brake system that, even in the event of a failure of one pressure build-up device 10 or 20, can still build up hydraulic pressure for actuating the brake elements R1 to R4 by means of the respectively remaining operational pressure build-up device 10 or 20.

The first pressure build-up device 10 and the second pressure build-up device 20 are supplied by two independent energy supply networks 30, 40. This can additionally ensure that, even in the event of a failure or a malfunction in one of the two energy supply networks 30, 40, hydraulic pressure can still be built up by means of the pressure build-up device 10 or 20 supplied by the respectively intact energy supply network 30, 40. For this purpose, according to the present invention, the first pressure build-up device 10 is fed from the high-voltage network 30 of an electric vehicle, while the second pressure build-up device 20 is fed from the low-voltage network 40 of an electric vehicle. Since an electric vehicle usually already has such a high-voltage network 30 and low-voltage network 40, no additional energy supply network is required for the energy supply of the brake system 1 by means of two independent energy supply networks 30, 40. In particular, use can be made of the fact that electric motors, such as those used in an electromechanical drive 12, can also be operated at relatively high supply voltages of 50 volts, 100 volts, or more. An energy supply of the first pressure build-up device 10 via a high-voltage network 30 of an electric vehicle is therefore not difficult.

Since the second pressure build-up device 20 is, for example, a vehicle dynamics control, such as an electronic stability program or the like, which comprises a plurality of components, such as electrically controlled valves, and such electronically controlled valves generally allow a relatively low supply voltage in the range of only a few volts, the second pressure build-up device 20 is supplied with electrical energy via the low-voltage network 40 of an electric vehicle. In the case of an energy supply of the first pressure build-up device 10 with the electromechanical drive 12 and the master brake cylinder 11 by means of the high-voltage network 30 and an energy supply of the second pressure build-up device 20 in a vehicle dynamics control by means of the low-voltage network 40 of the electric vehicle, respectively suitable supply voltages are thus provided for both pressure build-up devices 10 and 20, without having to implement an additional energy supply network in the electric vehicle.

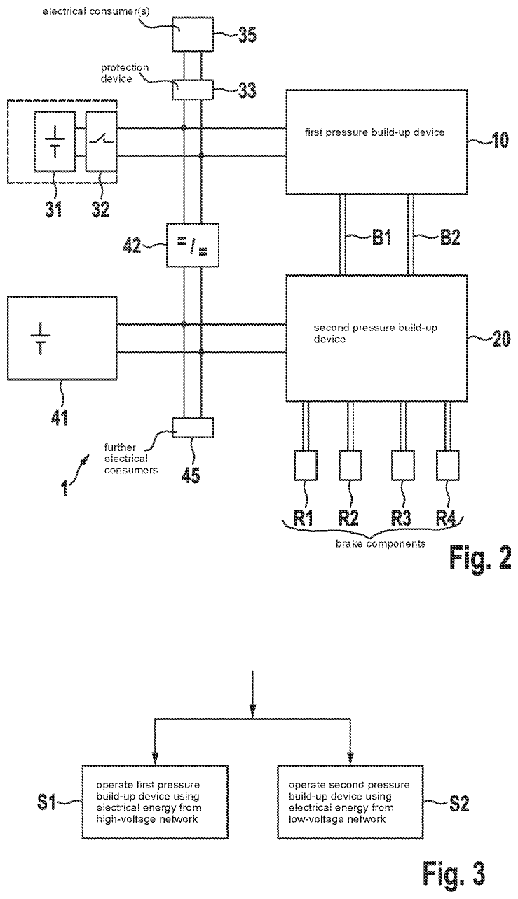

FIG. 2 shows a schematic illustration of a block diagram of a brake system 1 for an electric vehicle according to a further embodiment. The statements regarding the brake system 1 for an electric system that were already made above in connection with FIG. 1 also apply, to the extent that they are meaningful, to the embodiment according to FIG. 2. Analogously, the statements made below in connection with FIG. 2 can also be applied, to the extent that they are applicable, to the brake system 1 according to FIG. 1.

As can be seen in FIG. 2, the high-voltage network 30 of an electric vehicle may, for example, comprise a traction battery 31. A disconnector 32 can be provided at the output of the traction battery 31. For example, this disconnector 32 may be a switching element that can disconnect the internal terminals of the traction battery 31 from the output terminals of the traction battery 31. For example, this disconnector 32 may be a so-called manual service disconnect (MSD) or the like. Such a disconnector 32 makes it possible, for example, to switch the high-voltage network 30 completely to zero potential during maintenance of the electric vehicle or in a hazardous situation. In addition, the high-voltage network 30 may feed one or more electrical consumers 35. These consumers may, for example, be an electric drive system of an electric vehicle or further high-voltage consumer, such as an air-conditioning unit or the like. The further electrical consumer 35 may, for example, be connected to the output terminal of the disconnector 32 via an additional protection device 33.

As can further be seen in FIG. 2, the first pressure build-up device 10 is directly electrically connected to the outputs of the disconnector 32. This can ensure that the first pressure build-up device 10 continues to be supplied with electrical energy even if the protection device 33 is tripped. For example, if the protection device 33 is tripped due to a malfunction in one of the connected components 35, the energy supply of the first pressure build-up device 10 is not interrupted as a result. Thus, it is still possible to build up hydraulic pressure in the brake circuits B1 and B2 by means of the first pressure build-up device 10.

The low-voltage network 40 comprises an electrical energy store 41. For example, this energy store may be a 12-volt or 24-volt battery in the low-voltage network. The low-voltage network 40 may be coupled to the high-voltage network 30 via a DC voltage converter 42. Energy exchange between the high-voltage network 30 and the low-voltage network 40 is thus possible. In particular, the battery 41 of the low-voltage network can be charged from the high-voltage network 30 via the DC voltage converter 42. In addition, even further electrical consumers 45 can be connected to the low-voltage network 40.

FIG. 3 shows a flowchart as is the basis of a method for operating a brake system in an electric vehicle according to an embodiment. The method described below can in particular be applied to one of the brake systems 1 described above for an electric vehicle.

In step S1, the first pressure build-up device is operated using electrical energy from the high-voltage network of the electric vehicle. At the same time, in step S2, the second pressure build-up device is operated using electrical energy from the low-voltage network of the electric vehicle.

If one of the two energy supply networks, either the high-voltage network 30 or the low-voltage network 40, fails, one of the two pressure build-up devices 10 or 20 can nevertheless continue to be operated by means of the respectively still operational energy supply network 30 or 40. Consequently, even in the event of a failure of one of the two energy supply networks, it is still possible to build up hydraulic pressure in the brake system.

Since the energy supply of the two pressure build-up devices 10 and 20 can use the energy supply networks already present in the electric vehicle, in particular the high-voltage network 30 and the low-voltage network 40, the brake system according to the present invention can be realized without a great amount of additional effort.

In summary, the present invention relates to a brake system for an electric vehicle. The brake system comprises two independent pressure build-up devices for building up hydraulic pressure in the brake circuits of the brake system. One of the pressure build-up devices is supplied with electrical energy via the high-voltage network of the electric vehicle. The other pressure build-up device is supplied with electrical energy via the low-voltage network of the electric vehicle.

1-10. (canceled)

11. A brake system for an electric vehicle having a high-voltage network and a low-voltage network, comprising:
a first pressure build-up device configured to build up hydraulic pressure in at least one brake circuit; and
a second pressure build-up device configured to build up hydraulic pressure in the at least one brake circuit;
wherein the first pressure build-up device configured to be supplied with electrical energy from the high-voltage network of the electric vehicle, and
the second pressure build-up device is configured to be supplied with electrical energy from the low-voltage network of the electric vehicle.

12. The brake system according to claim 11, wherein the first pressure build-up device includes:
a master brake cylinder configured to build up hydraulic pressure in the at least one brake circuit; and
an electromechanical drive configured to actuate the master brake cylinder;
wherein the electromechanical drive is configured to be supplied with electrical energy from the high-voltage network of the electric vehicle; and
wherein the second pressure build-up device includes a vehicle dynamics control configured to build up hydraulic pressure in the at least one brake circuit and to be supplied with electrical energy from the low-voltage network of the electric vehicle.

13. The brake system according to claim 12, wherein the vehicle dynamics control includes an electronic stability program.

14. The brake system according to claim 11, wherein the high-voltage network includes a traction battery having a disconnector, and wherein the first pressure build-up device is directly electrically connected to an output of the disconnector of the traction battery.

15. The brake system according to claim 11, wherein the low-voltage network includes an electrical energy store and a DC voltage converter, wherein the DC voltage converter is configured to convert electrical energy from the high-voltage network to the low-voltage network and to charge the electrical energy store in the low-volt network.

16. The brake system according to claim 11, wherein the electromechanical drive of the first pressure build-up device is configured to be operated at an electrical voltage of at least 50 volts.

17. The brake system according to claim 11, wherein the first pressure build-up device and the second pressure build-up device are respectively configured to build up the hydraulic pressure in the at least one brake circuit exclusively by means of an electrically driven actuator.

18. The brake system according to claim 11, wherein the first pressure build-up device and the second pressure build-up device are respectively configured to build up hydraulic pressure in a plurality of independent brake circuits.

19. An electric vehicle comprising:
a high-voltage network;
a low-voltage network; and
a brake system including:
a first pressure build-up device configured to build up hydraulic pressure in at least one brake circuit, and
a second pressure build-up device configured to build up hydraulic pressure in the at least one brake circuit,
wherein the first pressure build-up device configured to be supplied with electrical energy from the high-voltage network of the electric vehicle, and
wherein the second pressure build-up device is configured to be supplied with electrical energy from the low-voltage network of the electric vehicle.

20. A method for producing a brake system in an electric vehicle, the electric vehicle including:
a high-voltage network,
a low-voltage network, and
a brake system including:
a first pressure build-up device configured to build up hydraulic pressure in at least one brake circuit, and
a second pressure build-up device configured to build up hydraulic pressure in the at least one brake circuit,
wherein the first pressure build-up device configured to be supplied with electrical energy from the high-voltage network of the electric vehicle, and
wherein the second pressure build-up device is configured to be supplied with electrical energy from the low-voltage network of the electric vehicle
the method comprising the following steps:
operating the first pressure build-up device using electrical energy from the high-voltage network of the electric vehicle; and
operating the second pressure build-up device using electrical energy from the low-voltage network of the electric vehicle.
